(19) United States
(12) Patent Application Publication
(10) Pub. No.: US 2021/0300361 A1
(43) Pub. Date: Sep. 30, 2021

(54) OBSTACLE DETECTION DEVICE AND DRIVING ASSISTANCE SYSTEM

(71) Applicant: AISIN SEIKI KABUSHIKI KAISHA, Kariya-shi (JP)

(72) Inventors: Ippei SUGAE, Kariya-shi (JP); Koichi SASSA, Kariya-shi (JP)

(73) Assignee: AISIN SEIKI KABUSHIKI KAISHA, Kariya-shi (JP)

(21) Appl. No.: 17/199,617

(22) Filed: Mar. 12, 2021

(30) Foreign Application Priority Data
Mar. 30, 2020 (JP) 2020-061346

(51) Int. Cl. B60W 30/095; G08G 1/16; B60W 30/09

(52) U.S. Cl. CPC B60W 30/0956; G08G 1/166; B60W 2554/4044; B60W 2420/54; B60W 2554/4042; B60W 30/09

(57) ABSTRACT

An obstacle detection device includes: a first acquisition unit acquiring object information which is on an object present around a moving object and is generated based on information acquired by distance measuring sensors mounted on the moving object; a second acquisition unit acquiring moving object information on the moving object; a determination unit determining whether the object is an obstacle likely to come into contact with the moving object based on the object information and the moving object information; and a generation unit generating obstacle information on the obstacle. The object information includes object position information and relative speed information, the moving object information includes moving object speed information and predicted path information, and the determination unit determines whether the object is the obstacle based on the object position information, the relative speed information, the moving object speed information, and the predicted path information.

### CROSS REFERENCE TO RELATED APPLICATIONS

This application is based on and claims priority under 35 U.S.C. § 119 to Japanese Patent Application 2020-061346, filed on Mar. 30, 2020, the entire content of which is incorporated herein by reference.

### TECHNICAL FIELD

This disclosure relates to an obstacle detection device and a driving assistance system.

### BACKGROUND DISCUSSION

In a system which supports driving of a moving object such as a vehicle, a technique of detecting an obstacle present around the moving object based on information acquired by a distance measuring sensor such as an ultrasonic sensor (sonar) provided on the moving object is used.

For example, for a purpose of improving detection accuracy, JP 2018-179782A (Reference 1) discloses a technique in which a direction in which an obstacle is present is detected based on an image captured by a camera provided on a moving object, and an operation frequency of transmission and reception of an ultrasonic wave of an ultrasonic sensor corresponding to the direction is increased.

An object present around the moving object can be detected by using the distance measuring sensor such as the ultrasonic sensor, but the detected object is not necessarily in contact with the moving object. Even when the object is present near the moving object, the moving object and the object may not come into contact with each other depending on a moving direction and a moving speed of the moving object or the object. In the related art, since movement of the object present around the moving object and movement of the moving object itself are not taken into consideration, it is difficult to detect an obstacle, which is an object that may come into contact with the moving object, with high accuracy.

A need thus exists for an obstacle detection device and a driving assistance system which are not susceptible to the drawback mentioned above.

### SUMMARY

An obstacle detection device according to this disclosure includes a first acquisition unit configured to acquire object information which is on an object present around a moving object and is generated based on information acquired by a plurality of distance measuring sensors mounted on the moving object, a second acquisition unit configured to acquire moving object information on the moving object, a determination unit configured to determine whether the object is an obstacle that is likely to come into contact with the moving object based on the object information and the moving object information, and a generation unit configured to generate obstacle information on the obstacle. The object information includes object position information indicating a position of the object and relative speed information indicating a relative speed of the object with respect to the moving object. The moving object information includes moving object speed information indicating a speed of the moving object and predicted path information indicating a predicted path which is a future moving path of the moving object. The determination unit determines whether the object is the obstacle based on the object position information, the relative speed information, the moving object speed information, and the predicted path information.

A driving assistance system according to this disclosure includes a control unit configured to control the moving object so as to avoid contact between the moving object and the obstacle based on obstacle information generated by the obstacle detection device described above.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating an example of a configuration of a vehicle on which an obstacle detection device and a driving assistance system according to a first embodiment are mounted;

FIG. 2 is a top view illustrating an example of the configuration of the vehicle on which the obstacle detection device and the driving assistance system according to the first embodiment are mounted;

FIG. 3 is a block diagram illustrating an example of a hardware configuration of the driving assistance system according to the embodiment;

FIG. 4 is a block diagram illustrating an example of a functional configuration of an ECU according to the embodiment;

FIG. 5 is a sequence diagram illustrating an example of a processing flow by the ECU according to the first embodiment;

FIG. 6 is a diagram illustrating an example of a waveform of an ultrasonic wave transmitted and received by a distance measuring sensor when a distance to an object is detected by a TOF method;

FIG. 7 is a diagram illustrating an example of a Doppler shift that occurs between a transmission wave transmitted from the distance measuring sensor and a reception wave obtained by the transmission wave being reflected by the object and returns;

FIG. 8 is a diagram illustrating an example of a situation in which an obstacle is detected by the ECU according to the first embodiment;

FIG. 9 is a sequence diagram illustrating an example of a processing flow by the ECU according to a second embodiment; and

FIG. 10 is a diagram illustrating an example of a situation in which an obstacle is detected by the ECU according to the second embodiment.

### DETAILED DESCRIPTION

Hereinafter, embodiments disclosed here will be disclosed. Configurations of the embodiments to be described later and operations and effects brought about by the configurations are examples. The disclosure can be implemented by configurations other than those disclosed in the following embodiments, and at least one of various effects and derived effects based on the basic configuration can be obtained.

### First Embodiment

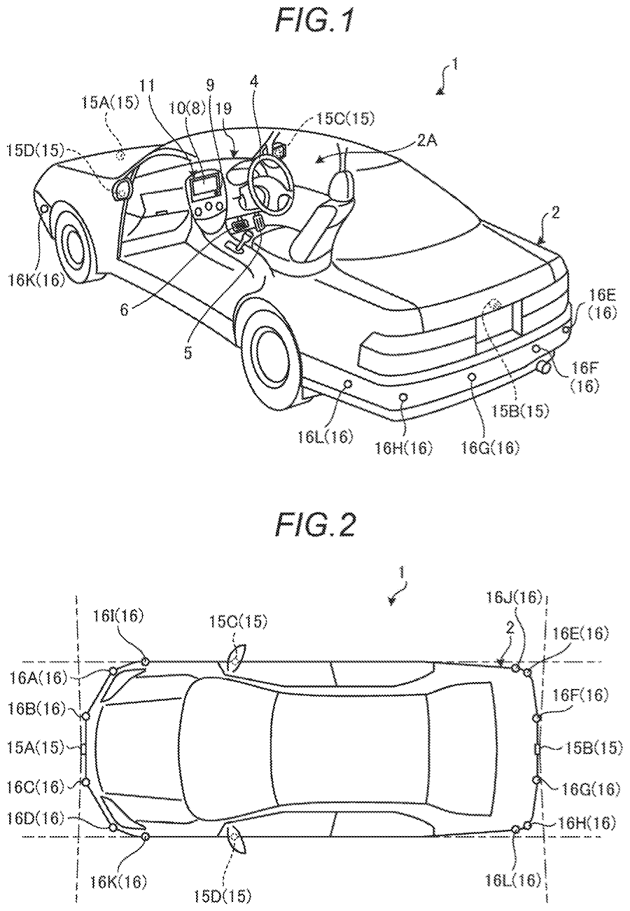

FIG. 1 is a perspective view illustrating an example of a configuration of a vehicle 1 on which an obstacle detection device and a driving assistance system according to a first embodiment are mounted. FIG. 2 is a top view illustrating an example of the configuration of the vehicle 1 on which the obstacle detection device and the driving assistance system according to the first embodiment are mounted.

The vehicle 1 according to the present embodiment is an example of a “moving object”. The vehicle 1 may be, for example, an internal combustion engine automobile using an internal combustion engine as a drive source, an electric automobile or a fuel cell automobile using an electric motor as the drive source, a hybrid automobile using both the internal combustion engine and the electric motor as the drive sources, or an automobile including another drive source.

As illustrated in FIG. 1, a vehicle body 2 of the vehicle 1 includes a passenger compartment 2A in which an occupant sits. A steering unit 4, an acceleration operation unit 5, a brake operation unit 6, a shift operation unit 7, a display device 8, a sound output device 9, a monitor device 11, and the like are provided in the passenger compartment 2A.

The steering unit 4 is, for example, a steering wheel protruding from a dashboard 19. The acceleration operation unit 5 is, for example, an accelerator pedal located under a foot of a driver. The brake operation unit 6 is, for example, a brake pedal located under the foot of the driver. The shift operation unit 7 is, for example, a shift lever protruding from a center console.

The display device 8 is a device which displays a predetermined image, and is, for example, a liquid crystal display (LCD) or an organic electroluminescent display (OELD). The display device 8 may be covered with an operation input unit 10 such as a touch panel. The occupant can visually recognize an image displayed on a display screen of the display device 8, and can freely perform an input operation by operating the operation input unit 10 with a finger or the like. The sound output device 9 is, for example, a speaker, and outputs sound corresponding to various functions such as navigation and warning. The monitor device 11 is a unit including the display device 8, the sound output device 9, and the like as described above, and may include operation units such as a switch, a dial, a joystick, and a push button. The monitor device 11 may also be used as, for example, a navigation system and an audio system. A sound output device different from the sound output device 9 may be provided at a position different from that of the monitor device 11.

A plurality of (four in the present example) image capturing devices 15A, 15B, 15C, and 15D are mounted on the vehicle 1 according to the present embodiment. Hereinafter, when it is not necessary to distinguish the image capturing devices 15A to 15D, the image capturing devices 15A to 15D may be referred to as an image capturing device 15. The image capturing device 15 is, for example, a digital camera including image capturing elements such as a charge coupled device (CCD) and a CMOS image sensor (CIS). The image capturing device 15 sequentially captures an image of the surrounding environment of the vehicle 1, and outputs acquired image data as video data at a predetermined frame rate.

Further, a plurality of (twelve in the present example) distance measuring sensors 16A, 16B, 16C, 16D, 16E, 16F, 16G, 16H, 16I, 16J, 16K, and 16L are mounted on the vehicle 1 according to the present embodiment. Hereinafter, when it is not necessary to distinguish the distance measuring sensors 16A to 16L, the distance measuring sensors 16A to 16L may be referred to as a distance measuring sensor 16. The distance measuring sensor 16 according to the present embodiment is an ultrasonic sensor (sonar) which detects a distance to an object using reflection of an ultrasonic wave. The distance measuring sensors 16A to 16D mainly detect an object present in front of the vehicle body 2. The distance measuring sensors 16E to 16H mainly detect an object present behind the vehicle body 2. The distance measuring sensors 16I and 16J mainly detect an object present on a right side of the vehicle body 2. The distance measuring sensors 16K and 16L mainly detect an object present on a left side of the vehicle body 2. By using information acquired by the plurality of distance measuring sensors 16 as described above, a position, a moving speed, a moving direction, and the like of the object present around the vehicle 1 can be measured. It should be noted that a type, the number, an arrangement, and the like of the distance measuring sensors shown here are merely examples, and the present disclosure is not limited thereto.

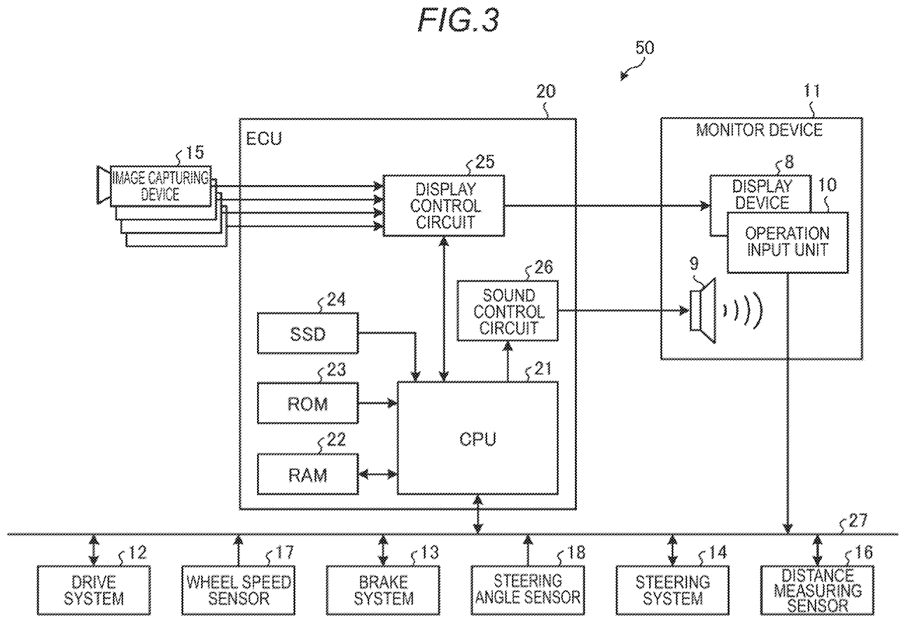

FIG. 3 is a block diagram illustrating an example of a hardware configuration of a driving assistance system 50 according to the embodiment. The driving assistance system 50 includes a drive system 12, a brake system 13, a steering system 14, a wheel speed sensor 17, a steering angle sensor 18, and an electronic control unit (ECU) 20 (obstacle detection device) in addition to the monitor device 11, the image capturing device 15, and the distance measuring sensor 16 described above.

The drive system 12 includes the drive source such as the internal combustion engine and an electric motor, and applies a driving force according to an operation to the acceleration operation unit 5 to wheels of the vehicle 1. The brake system 13 generates a braking force for preventing rotation of the wheels according to an operation to the brake operation unit 6. The brake system 13 may include, for example, an anti-lock brake system (ABS) which prevents lock of the wheels, an electric stability control (ESC) which prevents a side slip of the vehicle 1, a brake by wire (BBW) which increases the braking force. The steering system 14 may include, for example, an electric power steering system and a steer by wire (SBW) system which change a steering angle of front wheels of the vehicle 1 according to an operation to the steering unit 4.

The wheel speed sensor 17 is a sensor which detects a rotation amount and a rotation speed per unit time of the wheels. The wheel speed sensor 17 outputs, for example, a wheel speed pulse number indicating the detected rotation speed as a sensor value, and may be configured using a Hall element. The steering angle sensor 18 is a sensor which detects a displacement amount (rotation angle) of the steering unit 4 such as the steering wheel. The steering angle sensor 18 may be configured using, for example, the Hall element.

The ECU 20 is a unit for controlling various mechanisms and devices constituting the vehicle 1. The ECU 20 according to the present embodiment has a function of performing processing for detecting the obstacle, and is an example of the “obstacle detection device”. The ECU 20 is connected to the drive system 12, the brake system 13, the steering system 14, the distance measuring sensor 16, the wheel speed sensor 17, and the steering angle sensor 18 via an in-vehicle network 27, and is connected to the monitor device 11 and the image capturing device 15 via a local interconnect network (LIN). The in-vehicle network 27 is, for example, a controller area network (CAN). The in-vehicle network 27 is not limited to the CAN, and may be configured using the LIN or other networks. The distance measuring sensor 16 may be directly connected to the ECU 20 via the LIN. The ECU 20 generates a control signal for controlling the monitor device 11, the drive system 12, the brake system 13, and the steering system 14 by using detection signals of the distance measuring sensor 16, the wheel speed sensor 17, and the steering angle sensor 18. The control signal generated by the ECU 20 is transmitted to a target mechanism through the in-vehicle network 27, the LIN, and the like.

The ECU 20 includes a central processing unit (CPU) 21, a random access memory (RAM) 22, a read only memory (ROM) 23, a solid state drive (SSD) 24, a display control circuit 25, a sound control circuit 26, and the like.

The CPU 21 performs arithmetic processing for controlling the monitor device 11, the drive system 12, the brake system 13, and the steering system 14. The CPU 21 performs the arithmetic processing in accordance with a program stored in a non-volatile storage medium such as the ROM 23. The RAM 22 temporarily stores various types of data used in calculation performed by the CPU 21. The SSD 24 is a rewritable non-volatile storage medium, and can store data even when the ECU 20 is powered off. The CPU 21 performs, for example, processing for performing image processing related to the image displayed on the monitor device 11, determination of a movement target position of the vehicle 1, calculation of a predicted path of the vehicle 1, control of the drive system 12, control of the brake system 13, control of the steering system 14, detection of the obstacle to be described later, or the like.

The display control circuit 25 is a circuit which performs the image processing using the image data acquired by the image capturing device 15 and synthesis of the image data displayed on the display device 8 of the monitor device 11. The sound control circuit 26 is a circuit which performs processing of generating sound data output from the sound output device 9 of the monitor device 11.

The present embodiment illustrates a state where the CPU 21, the RAM 22, the ROM 23, the SSD 24, the display control circuit 25, and the sound control circuit 26 are integrated in the same package, but a form of the ECU 20 is not limited thereto. For example, the ECU 20 may be configured using not only one CPU 21 but also a plurality of CPUs. In this case, the CPUs perform processing for implementing different functions individually or in cooperation with each other. Further, another logical calculation processor such as a digital signal processor (DSP) or another logic circuit may be used instead of or in addition to the CPU 21. Further, a hard disk drive (HDD) may be provided instead of the SSD 24, and the SSD 24 and the HDD may be provided separately from the ECU 20.

The ECU 20 configured as described above performs the processing for detecting the obstacle present around the vehicle 1. The “obstacle” as used herein means an object that may come into contact with the vehicle 1. That is, the ECU 20 according to the present embodiment performs processing of determining which object among one or more objects present around the vehicle 1 is the obstacle. Information on the obstacle (obstacle information) is used for control for avoiding contact between the vehicle 1 and the obstacle.

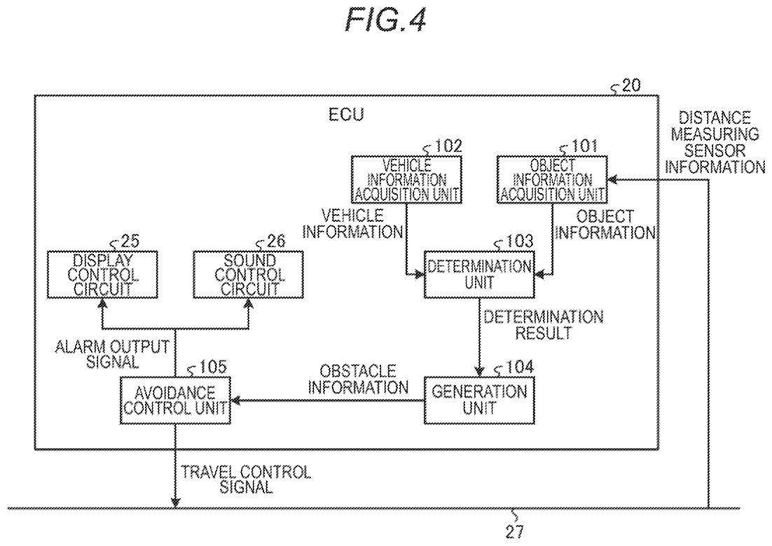

FIG. 4 is a block diagram illustrating an example of a functional configuration of the ECU 20 according to the embodiment. The ECU 20 includes an object information acquisition unit 101 (first acquisition unit), a vehicle information acquisition unit 102 (second acquisition unit), a determination unit 103, a generation unit 104, and an avoidance control unit 105 (control unit). These functional units 101 to 105 are implemented by cooperation of programs stored in the CPU 21, the RAM 22, the ROM 23, the SSD 24, and the like.

The object information acquisition unit 101 acquires object information on the object present around the vehicle 1. The object information is generated based on distance measuring sensor information acquired by the plurality of distance measuring sensors 16. The object information according to the present embodiment includes object position information indicating the position of the object and relative speed information indicating a relative speed of the object with respect to the vehicle 1. The object position information and the relative speed information are generated based on, for example, information indicating a distance from the vehicle 1 (distance measuring sensor 16) to the object, and information on Doppler shift occurring between a transmission wave and a reception wave according to the movement of the object or the vehicle 1.

The vehicle information acquisition unit 102 acquires vehicle information (moving object information) on the vehicle 1. The vehicle information includes vehicle speed information indicating a speed of the vehicle 1 and predicted path information indicating a predicted path which is a future moving path of the vehicle 1. The vehicle speed information is generated based on, for example, a detection result of the wheel speed sensor 17, an operation amount of the acceleration operation unit 5, and a target speed in automatic travel control. The predicted path information is generated based on, for example, a detection result of the steering angle sensor 18 and a target steering angle in the automatic travel control.

The determination unit 103 determines whether the object present around the vehicle 1 is the obstacle that may come into contact with the vehicle 1 based on the object information and the vehicle information. The determination unit 103 according to the present embodiment determines whether the object whose presence is detected by the distance measuring sensor 16 is the obstacle based on the object position information and the relative speed information included in the object information, and the vehicle speed information and the predicted path information included in the vehicle information. A method of determining whether the object is the obstacle is not particularly limited, and for example, whether the object is present on the predicted path of the vehicle 1 can be determined based on an increase or decrease in a distance between the object and the vehicle 1. For example, when the object is present on the predicted path and the object is moving away from the vehicle 1, the object can be excluded from an obstacle candidate.

The generation unit 104 generates the obstacle information on the obstacle (the object determined by the determination unit 103 to have a possibility of coming into contact with the vehicle 1). The obstacle information includes, for example, a position, a relative speed, a moving direction, a size, and the like of the obstacle.

The avoidance control unit 105 controls the vehicle 1 so as to avoid contact with the obstacle based on the obstacle information generated by the generation unit 104. The avoidance control unit 105 generates, for example, a travel control signal for controlling a traveling state of the vehicle 1, and an alarm output signal for outputting alarm information to the driver. The travel control signal includes, for example, a braking instruction signal for stopping or decelerating the vehicle 1 and a turning instruction signal for changing a traveling direction of the vehicle 1. The alarm output signal includes, for example, an image output signal for causing the display device 8 to display an image for calling attention and a sound output signal for causing the sound output device 9 to output a sound for calling attention.

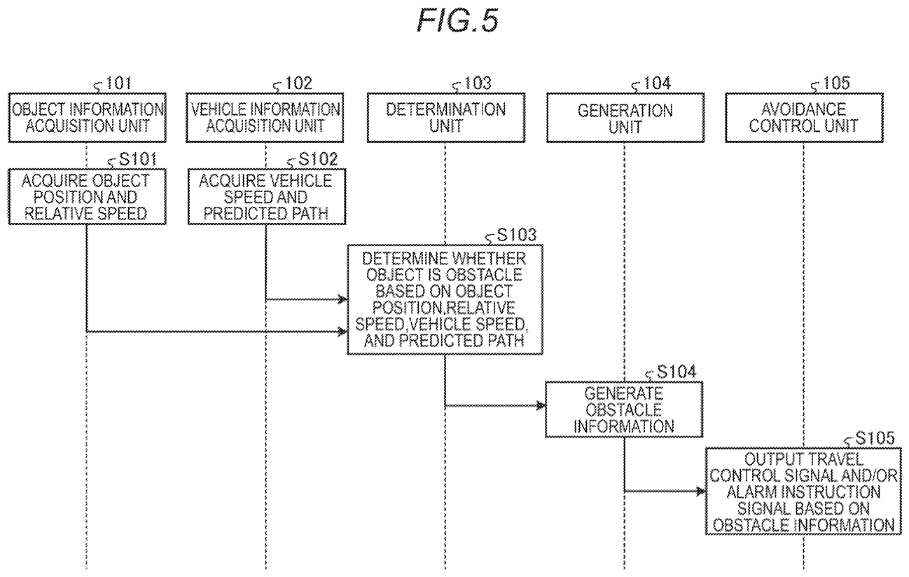

FIG. 5 is a sequence diagram illustrating an example of a processing flow by the ECU 20 according to the first embodiment. First, the object information acquisition unit 101 acquires the object position information and the relative speed information based on the detection results of the plurality of distance measuring sensors 16 (S101), and the vehicle information acquisition unit 102 acquires the vehicle speed information and the predicted path information (S102). Then, the determination unit 103 determines whether the object is the obstacle based on the object position information, the relative speed information, the vehicle speed information, and the predicted path information (S103), and the generation unit 104 generates the obstacle information on the obstacle (S104). The avoidance control unit 105 outputs the travel control signal and/or the alarm instruction signal based on the obstacle information (S105).

With the above-described configuration and processing, it is determined which object among one or more objects present around the vehicle 1 is the obstacle, and it is possible to take an avoidance action only for the object determined to be the obstacle.

Here, a method of detecting the distance from the vehicle 1 to the object by a technique called a so-called time of flight (TOF) method will be described. The TOF method is a method of converting a time (TOF) calculated from a difference between a timing at which the transmission wave such as the ultrasonic wave is transmitted (more specifically, starts to be transmitted) and a timing at which the reception wave, which is obtained by the transmission wave being reflected by the object to return, is received (more specifically, starts to be received) into a distance to the object.

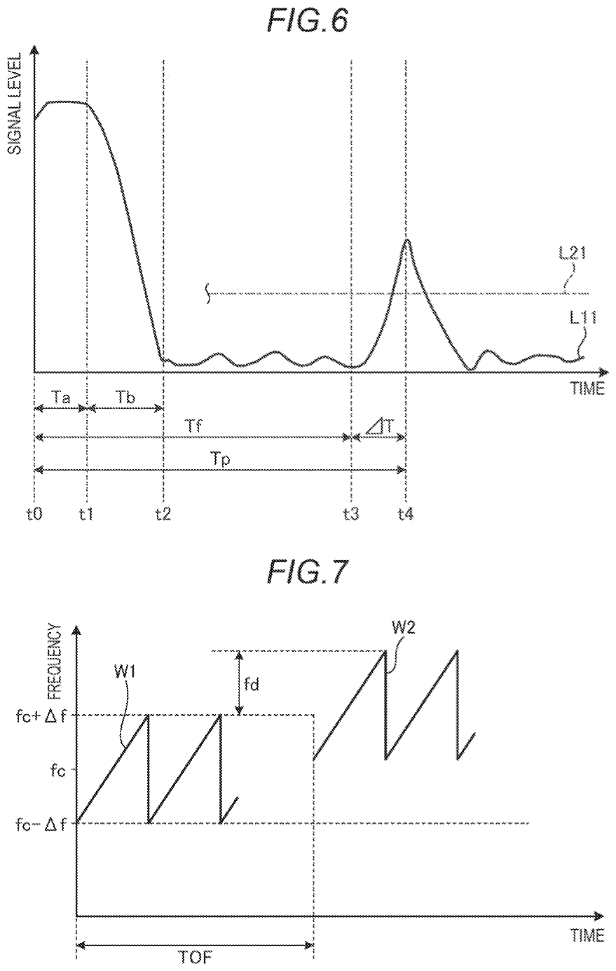

FIG. 6 is a diagram illustrating an example of a waveform of the ultrasonic wave transmitted and received by the distance measuring sensor 16 when the distance to the object is detected by the TOF method. The figure exemplarily and schematically illustrates a temporal change in a signal level (for example, amplitude) of the ultrasonic wave transmitted and received by the distance measuring sensor 16 in a form of a graph. In the figure, a horizontal axis corresponds to a time (elapsed time), and a vertical axis corresponds to the signal level.

A solid line L11 represents an example of an envelope representing the temporal change in the signal level of the signal transmitted and received by the distance measuring sensor 16 (a degree of vibration of a vibrator mounted on the distance measuring sensor 16). It can be seen from the solid line L11 that the vibrator is driven and vibrated for a time Ta from a timing t0, whereby the transmission of the transmission wave is completed at a timing t1, and then the vibration of the vibrator due to inertia continues while being attenuated during a time Tb until a timing t2 is reached. Therefore, the time Tb corresponds to a so-called reverberation time.

The solid line L11 reaches a peak at which the degree of vibration of the vibrator exceeds a threshold indicated by a dashed-dotted line L21 at a timing t4 at which a time Tp elapses from the timing t0 at which the transmission of the transmission wave is started. The threshold is a value set in advance to identify whether it is a reception wave which is obtained by the transmission wave from the vibrator being reflected by the object to be detected to return, or it is a reception wave which is obtained by the transmission wave being reflected by an object (for example, a road surface) other than the object to be detected to return. FIG. 3 illustrates an example in which the threshold is set as a constant value which does not change over time, but the threshold may be set as a value which changes over time. Therefore, it can be seen from the solid line L11 that the signal level at the timing t4 is caused by the reception wave which is obtained by the transmission wave being reflected by the object to be detected to return.

Further, in the solid line L11, the signal level is attenuated after the timing t4. Therefore, the timing t4 corresponds to a timing at which the reception of the reception wave, which is obtained by the transmission wave being reflected by the object to be detected to return, is completed, in other words, a timing at which the transmission wave transmitted last at the timing t1 returns as the reception wave.

Further, in the solid line L11, a timing t3 as a start point of the peak at the timing t4 corresponds to a timing at which the reception of the reception wave, which is obtained by the transmission wave being reflected by the object to be detected to return, is started, in other words, a timing at which the transmission wave transmitted first at the timing t0 is returned as the reception wave. Therefore, in the solid line L11, a time ΔT between the timing t3 and the timing t4 is equal to the time Ta as a transmission time of the transmission wave.

Based on the above, in order to obtain the distance to the object by the TOF method, it is necessary to obtain a time Tf between the timing t0 at which the transmission wave starts to be transmitted and the timing t3 at which the reception wave starts to be received. The time Tf can be obtained by subtracting the time ΔT equal to the time Ta as the transmission time of the transmission wave from the time Tp as the difference between the timing t0 and the timing t4 at which the signal level of the reception wave reaches the peak exceeding the threshold.

The timing t0 at which the transmission wave starts to be transmitted can be easily specified as a timing at which the distance measuring sensor 16 starts to operate. The time Ta as the transmission time of the transmission wave is a value that can be set in advance. Therefore, in order to obtain the distance to the object by the TOF method, it is sufficient to specify the timing t4 at which the signal level of the reception wave reaches the peak exceeding the threshold. The distance from the distance measuring sensor 16 to the object can be measured based on the time Tf (TO F) obtained in this way.

In the present embodiment, the distance to the object is measured by the plurality of distance measuring sensors 16A to 16L, and the positions of the distance measuring sensors 16A to 16L in the vehicle 1 (vehicle body 2) are unchanged. Therefore, the position of the object can be specified by a method similar to triangulation.

Next, the Doppler shift will be described. FIG. 7 is a diagram illustrating an example of the Doppler shift that occurs between the transmission wave transmitted from the distance measuring sensor 16 and the reception wave obtained by the transmission wave being reflected by the object to return. The figure illustrates a case in which frequency modulation is performed on the transmission wave such that a frequency changes in a saw-tooth shape. In the figure, a horizontal axis corresponds to a time (elapsed time), and a vertical axis corresponds to frequencies of the transmission wave and the reception wave.

A waveform W1 indicates a frequency characteristic of the transmission wave, and a waveform W2 indicates a frequency characteristic of the reception wave. The waveform W1 of the transmission wave has a waveform corresponding to a chirp signal in which an instantaneous frequency changes in a range from fc−Δf to fc+Δf.

When a relative distance between the object and the distance measuring sensor 16 is reduced (when the vehicle 1 or/and the object are moving so as to approach each other), a frequency band of the reception wave indicated by the waveform W2 is shifted to a higher frequency side than a frequency band of the transmission wave indicated by the waveform W1 due to Doppler effect. At this time, although a difference occurs in the frequency band between the waveform W1 and the waveform W2, a common waveform characteristic in which the frequency changes in the saw-tooth shape over time appears. Therefore, by extracting a signal having the same waveform characteristic as the waveform W1 from the signal acquired after the transmission of the transmission wave, the waveform W2 corresponding to the reception wave obtained by the transmission wave being reflected by the object to return can be specified. When the relative distance increases (when the vehicle 1 or/and the object are moving away from each other), the frequency band indicated by the waveform W2 shifts to a lower frequency side than the frequency band indicated by the waveform W1.

As described above, by specifying the correspondence between the waveform W1 and the waveform W2, the TOF corresponding to the distance to the object and a frequency transition amount (frequency difference) fd generated between the transmission wave and the reception wave can be acquired. Further, the relative speed of the object with respect to the vehicle 1 (the distance measuring sensor 16) can be calculated based on the frequency transition amount fd.

As described above, the object position information and the relative speed information included in the object information can be generated using the TOF method, the triangulation, and the Doppler shift. However, the object position information and the relative speed information are not limited to such a generation method, and may be generated by appropriately using a known or new technique.

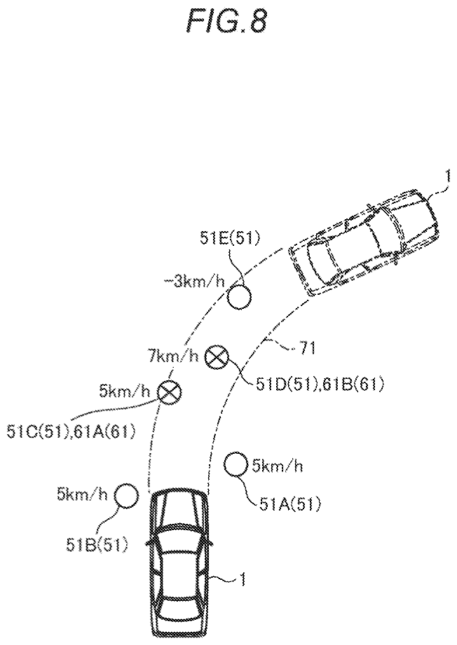

FIG. 8 is a diagram illustrating an example of a situation in which the obstacle is detected by the ECU 20 according to the first embodiment. FIG. 8 illustrates a situation in which five objects 51A, 51B, 51C, 51D, and 51E are present around the vehicle 1, and the three objects 51C, 51D, and 51E among the five objects are present on a predicted path 71 of the vehicle 1. Further, it is illustrated that a relative speed of the object 51A is 5 km/h, a relative speed of the object 51B is 5 km/h, a relative speed of the object 51C is 5 km/h, a relative speed of the object 51D is 7 km/h, and a relative speed of the fifth object is −3 km/h. In the present example, the vehicle 1 travels at a speed of 5 km/h along the predicted path 71, the objects 51A, 51B, and 51C are stopped, the object 51D moves in a direction approaching the vehicle 1, and the object 51E moves in a direction away from the vehicle 1. Hereinafter, when it is not necessary to distinguish the objects 51A to 51E, the objects 51A to 51E may be referred to as an object 51. When a value of the relative speed is positive, the distance between the vehicle 1 and the object 51 is reduced, and when the value of the relative speed is negative, the distance between the vehicle 1 and the object 51 is increased.

In the above situation, it is determined that only the two objects 51C and 51D among the five objects 51A to 51E are obstacles 61A and 61B. Hereinafter, when it is not necessary to distinguish the obstacles 61A and 61B, the obstacles 61A and 61B may be referred to as an obstacle 61. Since the objects 51C and 51D are present on the predicted path 71 and the relative speed thereof are the positive values, it is determined that the objects 51C and 51D are the obstacles 61A and 61B. Since the objects 51A and 51B are not present on the predicted path 71, the objects 51A and 51B are excluded from the obstacle candidate. Although the object 51E is present on the predicted path 71, since the relative speed thereof is the negative value, the object 51E is excluded from the obstacle candidate.

As described above, by determining whether the object 51 is the obstacle 61 based on the position and the relative speed of the object 51, and the speed and the predicted path 71 of the vehicle 1, the detection accuracy of the obstacle 61 can be improved. Further, since it is possible to prevent an excessive reaction to the objects 51A, 51B, and 51E determined not to come into contact with the vehicle 1, the control to the vehicle 1 for avoiding contact with the obstacle 61 can be efficiently performed.

A type of the driving assistance system 50 using the obstacle information as described above is not particularly limited, and may be, for example, a parking assistance system which automatically or semi-automatically performs traveling when the vehicle 1 is parked in a parking space and an automated valet system which automatically or semi-automatically performs traveling in a predetermined region such as a parking lot.

Further, the timing at which the processing for detecting the obstacle as described above is performed is not particularly limited, and the detection may be performed at all times while the vehicle is traveling, or may be performed only when an instruction is given by the driver.

Although an example in which the ultrasonic sensor is used as the distance measuring sensor 16 has been described above, the type of the distance measuring sensor 16 is not limited thereto. The distance measuring sensor 16 may be, for example, a millimeter wave radar and a laser imaging detection and ranging (LIDAR).

Further, a case in which the moving object is the vehicle 1 (an automatic four-wheel vehicle) has been described, but the type of the moving object is not limited thereto. The moving object may be, for example, an electric mobility and an autonomous mobile robot which can be used in a predetermined region (for example, a medical facility and an exhibition hall).

Hereinafter, another embodiment will be described with reference to the drawings, and the same reference numerals are given to portions having the same or similar functions and effects as those of the first embodiment, and the description thereof may be omitted.

### Second Embodiment

The ECU 20 (obstacle detection device) according to a second embodiment is different from that of the first embodiment in that object moving direction information indicating a moving direction of the object 51 is further taken into consideration when it is determined whether the object 51 is the obstacle 61.

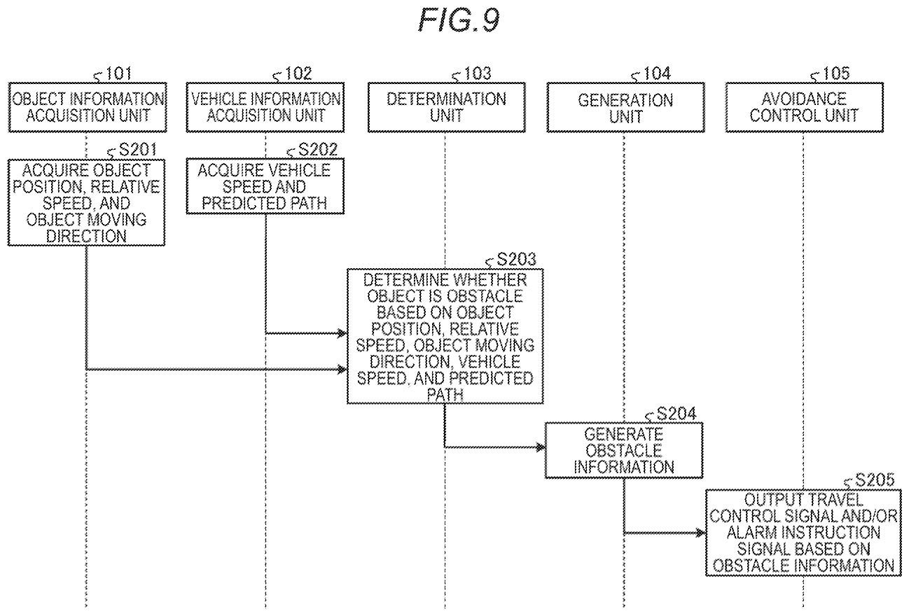

FIG. 9 is a sequence diagram illustrating an example of a processing flow by the ECU 20 according to the second embodiment. First, the object information acquisition unit 101 acquires object position information, the object moving direction information, and relative speed information based on detection results of a plurality of distance measuring sensors 16 (S201), and the vehicle information acquisition unit 102 acquires vehicle speed information and predicted path information (S202). Then, the determination unit 103 determines whether the object is the obstacle based on the object position information, the object moving direction information, the relative speed information, the vehicle speed information, and the predicted path information (S203), and the generation unit 104 generates obstacle information on the obstacle (S204). The avoidance control unit 105 outputs a travel control signal and/or an alarm instruction signal based on the obstacle information (S205).

A method of acquiring the object moving direction information is not particularly limited, and for example, a moving direction of the object 51 can be detected using a TOF method, triangulation, and a Doppler shift as described above.

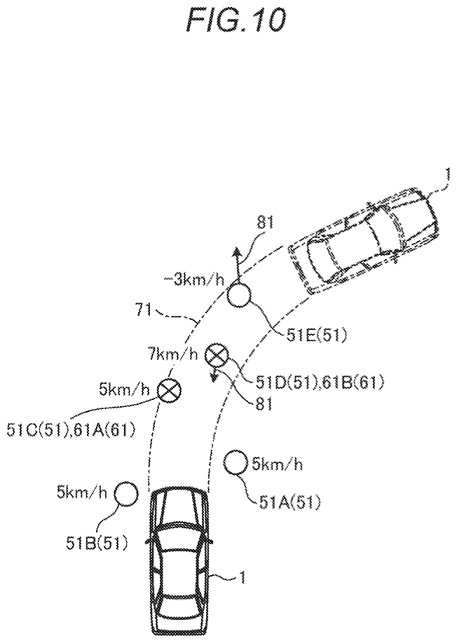

FIG. 10 is a diagram illustrating an example of a situation in which the obstacle is detected by the ECU 20 according to the second embodiment. FIG. 10 illustrates a situation in which the object 51D (obstacle 61B) moves in a direction approaching the vehicle 1 in the predicted path 71, and the object 51E moves in a direction away from the vehicle 1 and away from the predicted path 71. Further, although not illustrated, even when the object 51 is not present in the predicted path 71, it is also possible to determine that the object 51 moving so as to enter the predicted path 71 is the obstacle 61.

As described above, by determining a possibility of contact between the vehicle 1 and the object 51 in further consideration of a moving direction 81 of the object 51, the detection accuracy of the obstacle 61 can be further improved.

An obstacle detection device according to this disclosure includes a first acquisition unit configured to acquire object information which is on an object present around a moving object and is generated based on information acquired by a plurality of distance measuring sensors mounted on the moving object, a second acquisition unit configured to acquire moving object information on the moving object, a determination unit configured to determine whether the object is an obstacle that is likely to come into contact with the moving object based on the object information and the moving object information, and a generation unit configured to generate obstacle information on the obstacle. The object information includes object position information indicating a position of the object and relative speed information indicating a relative speed of the object with respect to the moving object. The moving object information includes moving object speed information indicating a speed of the moving object and predicted path information indicating a predicted path which is a future moving path of the moving object. The determination unit determines whether the object is the obstacle based on the object position information, the relative speed information, the moving object speed information, and the predicted path information.

According to the above configuration, it is determined whether the moving object and the object come into contact with each other based on the position of the object, the relative speed of the object with respect to the moving object, the speed of the moving object, and the predicted path of the moving object. Accordingly, detection accuracy of the obstacle that is an object that may come into contact with the moving object can be improved. When a detection result of the object by the distance measuring sensor is used for control of the moving object, an excessive reaction to the object determined not to come into contact with the moving object can be prevented, and controllability of the moving object can be improved.

Further, in the obstacle detection device described above, the determination unit may specify the object moving away from the moving object based on the relative speed information, and determine that the object moving away from the moving object is not the obstacle.

It is possible to determine that the object moving away from the moving object does not come into contact with the moving object even when the object is present on the predicted path. By such determination processing, the detection accuracy of the obstacle can be improved.

In the obstacle detection device described above, the object information may further include object moving direction information indicating a moving direction of the object. The determination unit may determine whether the object is the obstacle based on the object position information, the relative speed information, the object moving direction information, the moving object speed information, and the predicted path information.

In this way, by determining possibility of contact in consideration of the moving direction of the object, the detection accuracy of the obstacle can be further improved.

In the obstacle detection device described above, the distance measuring sensor may be an ultrasonic sensor.

The obstacle detection device having the above-described configuration can use the relatively inexpensive ultrasonic sensor as the distance measuring sensor. Accordingly, it is possible to simultaneously implement cost reduction, improvement in the detection accuracy, improvement in controllability of the vehicle, and the like.

A driving assistance system according to this disclosure includes a control unit configured to control the moving object so as to avoid contact between the moving object and the obstacle based on obstacle information generated by the obstacle detection device described above.

By controlling the moving object based on the obstacle information generated with high detection accuracy as described above, safety of the moving object can be improved. Specifically, since it is possible to prevent an excessive reaction to the object which is present around the moving object but does not come into contact with the moving object, it is possible to prevent unnecessary movement of the moving object and improve riding comfort.

While the embodiments disclosed here have been described, these embodiments are examples, and are not intended to limit the scope of this disclosure. The novel embodiments described above can be implemented in various forms, and various omissions, substitutions, and changes can be made without departing from the spirit of this disclosure. The embodiments described above are included in the scope and spirit of this disclosure and are also included in this disclosure described in the claims and the equivalent thereof.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An obstacle detection device comprising:
a first acquisition unit configured to acquire object information which is on an object present around a moving object and is generated based on information acquired by a plurality of distance measuring sensors mounted on the moving object;
a second acquisition unit configured to acquire moving object information on the moving object;
a determination unit configured to determine whether the object is an obstacle that is likely to come into contact with the moving object based on the object information and the moving object information; and
a generation unit configured to generate obstacle information on the obstacle, wherein
the object information includes object position information indicating a position of the object and relative speed information indicating a relative speed of the object with respect to the moving object,
the moving object information includes moving object speed information indicating a speed of the moving object and predicted path information indicating a predicted path which is a future moving path of the moving object, and
the determination unit determines whether the object is the obstacle based on the object position information, the relative speed information, the moving object speed information, and the predicted path information.

2. The obstacle detection device according to claim 1, wherein
the determination unit specifies the object moving away from the moving object based on the relative speed information, and determines that the object moving away from the moving object is not the obstacle.

3. The obstacle detection device according to claim 1, wherein
the object information further includes object moving direction information indicating a moving direction of the object, and
the determination unit determines whether the object is the obstacle based on the object position information, the relative speed information, the object moving direction information, the moving object speed information, and the predicted path information.

4. The obstacle detection device according to claim 1, wherein
the distance measuring sensor is an ultrasonic sensor.

5. A driving assistance system comprising:
a control unit configured to control the moving object so as to avoid contact between the moving object and the obstacle based on the obstacle information generated by the obstacle detection device according to claim 1.
